(19) United States
(12) Patent Application Publication
(10) Pub. No.: US 2004/0258805 A1
(43) Pub. Date: Dec. 23, 2004

(54) Confectionery product and method of preparation

(76) Inventors: Lior Halevy, Netanya (IL); Moshe Trop, Meitar (IL)

Correspondence Address: Brown Raysman Millstein, Felder & Steiner, 900 Third Avenue, New York, NY, 10022, US

(21) Appl. No.: 10/491,069

(22) PCT Filed: Jun. 30, 2003
(86) PCT No.: PCT/IL03/00548

(30) Foreign Application Priority Data
Jul. 31, 2002 (IL) 151013

(51) Int. Cl. A23G 1/00

(52) U.S. Cl. 426/100

(57) ABSTRACT

A confection comprising a capsule containing an alcoholic fluid embedded in a frozen dessert, wherein the capsule is inert with respect of the alcohol and the frozen dessert.

### FIELD OF THE INVENTION

The present invention relates to novel confectionery products, particularly to frozen desserts, and to methods of preparing them.

### BACKGROUND OF THE INVENTION

Confectioneries are popular with consumers of all ages, in most, if not all cultures, whether eaten as a snack, or as a dessert. This holds true for frozen and non-frozen confectionaries. In the International patent databases, within the International Patent Classification Group A 23 G, dedicated to cocoa, chocolate, confectionery and ice-cream, there are over 45,000 inventions—indicative of the creativity in this crowded art. The present invention is concerned with frozen desserts in all their variations.

Frozen desserts, come in many forms, such as ice cream, frappe, sherbet, mousse and ices. Thy come in different flavors and textures and as mixtures. They may be coated with chocolate or sprinkled with dried fruits or nuts and have a layer of whip cream.

One type of confection of contrasting textures and flavors that has become popular is chocolate coated confection and within this group are chocolate covered creams and alcoholic liquids such as cherry liqueur and vodka. Frozen desserts containing alcohol present a problem since alcohol has a much lower freezing point than water or aqueous solutions and is fully miscible therewith, the alcohol tends to dissolve any frozen dessert if kept in contact therewith for any significant time. Alcohol also has some solubility in fatty substances such as creams. It will therefore be appreciated that fabricating a stable alcoholic dessert, such as alcohol containing ice-cream having long shelf-lives is not a trivial business.

WO 97/15199 to Macleod, describes a rigid stable homogeneous frozen alcoholic confection that can be supported on a stick fabricated from a stabilized alcoholic beverage into which is dissolved a thickening and stabilizing solution. Similarly, U.S. Patent Application US 2001/0041208 to Orris et al. describes a stabilization process for producing a homogeneous ice-cream type product containing alcohol.

US 2001/0001675 to Akutagawa discloses a method for fabricating decorative foods, essentially by co-extruding a plurality of fluid (or pasty) food materials, including wine and liqueur and coating these with chocolate.

WO 02/21980 to Purcell et al. describes an edible cup, made of chocolate or ice, for filling with liqueur or other beverage, wherein the cup and beverage are both consumed. Such a cup-beverage combination provides contrasting textures and flavours between the solid cup and the liquid beverage. It will be appreciated however, that where the cup is made of ice, it cannot be used for storing alcoholic liquids, since alcohol melts ice. Somewhat similarly, WO95/30865 discloses a container made of ice for serving alcoholic beverages.

GB 2,355,641 describes an alcoholic beverage comprising a strong alcoholic liquid encased in a chewable sweet-like shell.

The prior art, thus, discloses frozen dessert confections containing alcohol (such as ice-creams and water ices), that are stabilized to form homogeneous mixtures enabling them to have a long shelf life. The prior art further discloses chocolate filled with alcoholic beverages such as chocolate coated cherry liqueurs and chocolate coated vodka. None of the references contemplate providing a storable frozen dessert containing a discrete Oalcoholic liquid having a long shelf life.

### SUMMARY OF THE INVENTION

It is an object of the present invention to provide a frozen dessert confection containing a discrete alcoholic liquid.

It is a further object of the invention to provide a method for producing such a confection.

In accordance with this invention there is provided a frozen dessert confection comprising a capsule containing an alcoholic fluid, embedded in a frozen dessert wherein the capsule is inert with respect of the alcoholic fluid and the frozen dessert.

The alcoholic fluid can be any alcohol containing beverage, preferably selected from the list of spirits, wines, beers and liqueurs.

The capsule can be made of edible or nonedible materials. The nonedible materials include plastics such as polyethylene, and these may be rigid or flexible. Rigid capsules will generally have caps that are easily removed with the teeth once the frozen confection has been eaten and the capsule exposed. Flexible capsules may be in the form of pouches and may have various shapes. Edible capsules can be divided into two kinds: edible polymeric materials and edible foods.

The preferred edible capsule is comprised of a solid or hard fat that has a sufficiently high melting point and low Iodine Value so that it is “inert”, i.e. it does not interact with alcohol or with the frozen dessert even when maintained slightly above freezing temperature. The hard fat may be flavored. Suitable hard fats are cocoa butter, certain high melting chocolates and hydrogenated oils and fats and highly saturated natural fats. Other ingredients, such as sugar, or other sweeteners, milk solids, emulsifiers, gelatin, gluten and albumen may also be present in quantities that do not seriously affect the “inert” property of the fat.

The frozen dessert is preferably selected from the list of ice-creams, sherbets, frozen yoghurts and water-ices. The frozen desserts may be further coated with chocolate, glazing or sprinkles, as is known in the art. The confection of this invention is generally marketed as individual discreet articles and not in bulk, for example, as sandwiches, with the frozen dessert held between two wafers of pastry, or as pop-sticks, or in a pastry cone, or in a Dixie™ cup. The confection is also preferably provided to the customer in a wrapping such as of coated paper, plastic or aluminum foil, as is common with frozen confections. The wrapping or packaging may be designed to also have a handle for facilitating holding it while eating the confection.

The present invention is also directed to a method of making such a confection comprising encapsulating an alcoholic liquid in an edible capsule that is non-reactive with alcohol or the frozen dessert, placing the capsule in a suitable mold, introducing into the mold a dessert mix, and freezing the mix to produce a frozen dessert confection.

Alternatively, the capsule containing the alcohol is directly inserted into a frozen dessert. This can be accomplished by providing a frozen dessert with a cavity therein into which the capsule is inserted, and the cavity closed with more frozen dessert material.

The frozen dessert, as well as the capsules embedded therein, can be manufactured in any shape and can conform to any known or imagined form. Thus, the capsules containing the alcoholic beverage may be round, oval, cylindrical, or in the shapes of bottles, hearts, trees, dolls, etc. The capsules may also have multiple compartments, with at least one compartment containing an alcoholic beverage, and the other compartments containing either a different alcoholic beverage or an altogether different type of edible confection.

### DESCRIPTION OF THE FIGURES

The present invention will be further understood and appreciated from the following detailed description taken in conjunction with the drawings in which:

FIG. 1 shows an ice-pop confection according to the present invention,

FIG. 2 shows an ice-cream sundae according to the present invention,

FIG. 3 illustrates a frozen dessert confection in the form of a cone according to the present invention,

FIG. 4 shows a frozen sherbet in a fluted pastry or paper dish according to the present invention,

FIG. 5 illustrates a confection of the invention in the form of a Dixie™ Cup,

FIG. 6 illustrates another embodiment of the invention,

FIG. 7 is a block diagram illustrating one method of manufacturing a confection in accordance with the present invention,

FIG. 8 is a block diagram illustrating another method of manufacturing a confection in accordance with the present invention.

### DETAILED DESCRIPTION

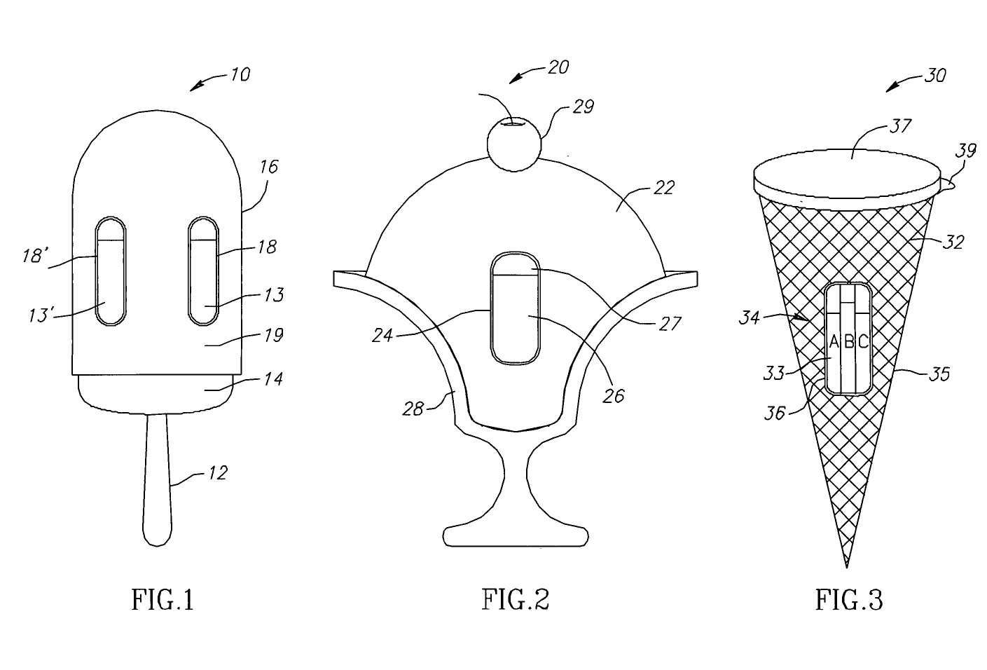

Referring now to FIG. 1 there is shown a frozen dessert confection 10 on a stick 12. The confection 10 consists of a core of frozen dessert 14 covered with chocolate coating 16. The stick 12 is held tight by the surrounding frozen dessert 14. Embedded in the dessert 14 are capsules 18, 18′ containing alcoholic liquids 13, 13′, which may or may not be the same. For example, 13 may be a liqueur such as Irish Cream, and 13′ may be vodka. The frozen dessert 14 may be ice-cream or ices. The capsules 18, 18′ may consist of a chocolate shell or other fatty material that is non-reactive with the alcohol 13, 13′ or the dessert 14. The confection 10 may contain additional components and/or garnishes 19, such as chocolate sprinkles, for example.

The possible combinations of frozen desserts and alcoholic liquids are almost infinite. There are also many known fatty materials suitable for making capsules for holding alcoholic beverages that will not leak and that will prevent diffusion of the beverage into the dessert. These fats, knows as hard fats, include cocoa butter, hydrogenated fats and oils and any hard fat having a relatively high melting point, above 35°. Typically, the recipe for the capsule may include ingredients such as sugar, cocoa solids, milk solids, gelatin, stabilizers, gluten or albumen, in amounts that will not affect the integrity of the capsule.

Referring now to FIG. 2, there is shown a confection 20, consisting of a frozen dessert 22, typically, ice-cream, sorbet, water-ice, frozen yoghurt, and the like, in which is embedded, a capsule 24, containing therein an alcoholic liquid 26 which is not completely filled to he top, leaving an empty space 27. The beverage may be a wine, or, a spirit, such as rum, whiskey or vodka, or a liqueur such as Irish Cream, Cherry Brandy, Amaretto, and the like. The frozen confection 20 is held in a container 28, such as a sundae glass, or any other dish or bowl. The confection 20 may also have additional garnishes such as a glace cherry 29 on top.

In FIG. 3, there is illustrated a confection 30 in the form of an edible cone 32 containing a frozen dessert 34 in which is embedded a multi-compartment capsule 36 containing an alcoholic liquid 33 in compartment A and either alcohol or other edible soft sweets in compartments B and C. The cone 32 is wrapped in a coated paper 35 having a tear off cover 37 with end tab 39.

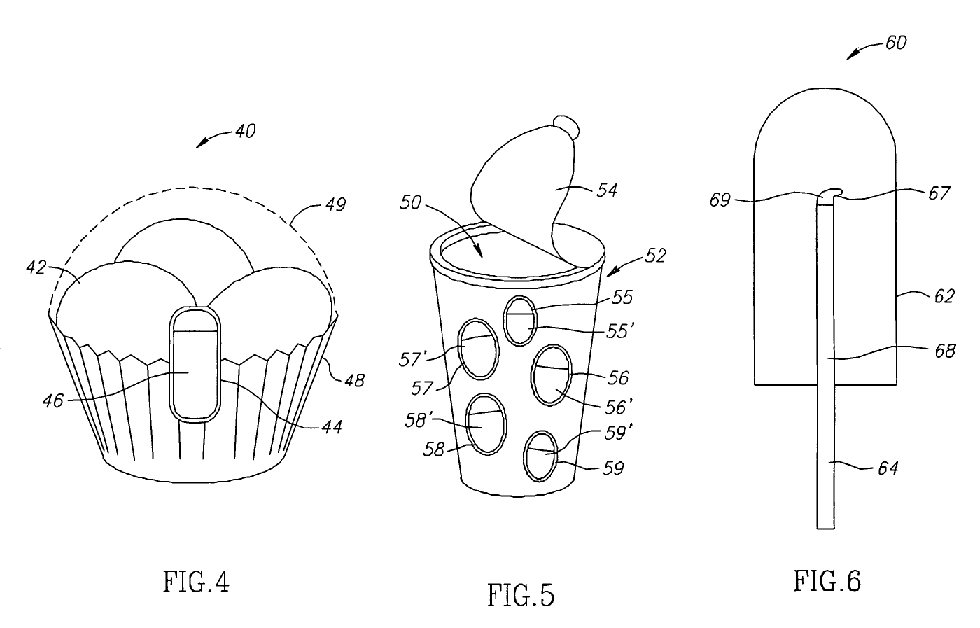

Referring now to FIG. 4, there is shown a confection 40, consisting of a frozen dessert 42, in which is embedded, a capsule 44, containing an alcoholic liquid 46. The capsule 44 is in the shape of a cylinder but it may have any shape and size. The confection 40, as shown, is contained in a disposable fluted container 48, which may be as insubstantial as simple paper or plastic. A removable lid 49 can be provided as a separate entity or integral with the container 48. An additional feature of the invention is that the capsules can be molded in any shape providing the confection with variety and added consumer interest, and can be used for advertising and other purposes.

FIG. 5 illustrates another form of packaging the frozen confection of this invention. The frozen dessert 50 is contained in a paper or plastic cup, such a Dixie™ cup 52 having a peel-off cover 54. In the frozen dessert 50 there are dispersed hollow edible balls 55, 56, 57, 58, 59 containing alcoholic beverages 55′, 56′, 57′, 58′, 59′ which may or may not be the same. The frozen dessert 50, in this instance, is eaten with a spoon (not shown), which is provided with the cup 52.

FIG. 6 illustrates another embodiment of the invention, showing an ice-pop 60 comprising a frozen dessert 62 and a stick 64 inserted into the frozen dessert 62. The stick 64 is essentially a tube which has a hollow section 66 containing an alcoholic liquid 68. On top of the hollow section 66 is a plug 69 which can be pulled out from the upper end of the hollow section 66 with one's teeth by biting on the tab 67.

The capsules, as mentioned above, may be formed in an almost infinite variety of shapes, including, by way of example only, bottles, fingers, babies' pacifiers, trees, light bulbs, dolls, animals, sky-scrapers and arrows.

The variety of serving containers with or without handles, the various flavors and textures of the capsule, frozen dessert and alcoholic liquid, and the virtually limitless variety of capsule and dessert shapes, plus the possible addition of coatings, garnishes and additional layers of dessert type foods, provides very many alternative embodiments, and the examples given hereabove, are exemplary only, and should not be construed as limiting.

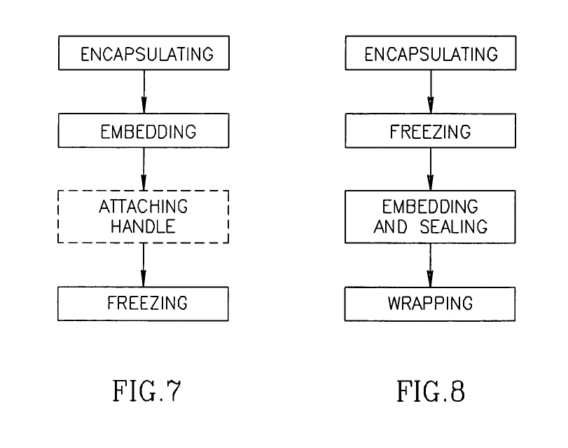

FIG. 7 is a flow diagram showing one method of making the confection according to this invention.

Step 1—encapsulating an alcoholic liquid within an edible capsule. This is known from the prior art, and may be performed using an injection device, for example.

Step 2—the capsule is then embedded within a dessert mix prior to freezing.

Step 3—a ‘handle’ such as a stick, is typically inserted in the dessert mix.

Step 4—is the dessert is then frozen, and can be stored as such for an extended period of time, with the alcoholic capsule embedded therein.

FIG. 8 is a flow diagram of an alternate method of making a confection according to the invention.

Step 1—is the same as in FIG. 1.

Step 2—freezing a dessert mix in a mold while leaving a cavity in the frozen dessert.

Step 3—inserting the capsule into the cavity of the frozen dessert and sealing the cavity with additional frozen dessert.

Step 4—placing the frozen dessert in a container and/or packaging it in a wrapper.

There are many variations of the methods shown above for purpose of illustration only, and these can easily be derived once one has decided what kind of frozen dessert one wishes to prepare.

Although described with reference to frozen desserts, edible capsules containing alcoholic fluids may also be incorporated within non-frozen gels and puddings. Capsules as described herein, may also be filled with non-alcoholic beverages, or with syrups, jams, fudges or other liquids, or semi-fluid pastes. Thus the basic invention described herein is applicable to a very wide variety of confections.

As was mentioned above, the capsules containing the alcoholic liquid may be edible or nonedible, comprised of natural or synthetic materials as long as these satisfy the requirements of being food-grade.

It will be appreciated that the invention is not limited to what has been described hereinabove merely by way of example. Rather, the invention is limited solely by the claims which follow.

1. A confection comprising a capsule containing an alcoholic fluid embedded in a frozen dessert, wherein the capsule is inert with respect of the alcohol and the frozen dessert.

2. A confection as claimed in claim 1, wherein the capsule comprises an edible material.

3. A confection as claimed in claim 1, wherein the capsule comprises a nonedible food-grade material.

4. A confection as claimed in claim 1, wherein said alcoholic fluid includes an alcoholic beverage selected from spirits, wines, beers and liqueurs.

5. A confection as claimed in claim 1, wherein said edible capsule is comprised of a hard fat selected from chocolate, cocoa butter, and hydrogenated oils and fats.

6. A confection as claimed in claim 5, further comprising an ingredient selected from milk solids, albumen, gelatin, emulsifier and gluten.

7. A confection as claimed in claim 1, wherein said frozen dessert is selected from ice-creams, frozen yogurts, sorbets and water-ices.

8. A confection as claimed in claim 1, further comprising means for holding the confection in a hand selected from a stick, a cone, a cup or a wrapper.

9. A confection as claimed in claim 1, wherein the capsule is a multi-compartment capsule, with at least one compartment containing an alcoholic liquid.

10. A confection as claimed in claim 1, containing more than 1 capsule.

11. A method of making a confection consisting of a capsule of edible material containing an alcoholic fluid, embedded in a frozen dessert, comprising the steps:
a. encapsulating an alcoholic liquid in an edible capsule,
b. embedding said capsule within a dessert mix, and
c. freezing said dessert.

12. A method of making a confection consisting of a capsule of edible material containing an alcoholic fluid, embedded in a frozen dessert, comprising the steps:
a. encapsulating an alcoholic liquid in an edible capsule,
b. freezing a dessert mix in a mold while leaving a cavity in the frozen dessert,
c. inserting the capsule into the cavity of the frozen dessert and sealing the cavity with additional frozen dessert,
d. placing the frozen dessert in a container and/or packaging it in a wrapper.

13. A method of making a confection as claimed in claim 11, further comprising coupling said confection to a handle selected from a cup, cone, stick, and wrappers.

14-15. (Cancelled)

16. A method of making a confection as claimed in claim 12, further comprising coupling said confection to a handle selected from a cup, cone, stick, and wrappers.
